(19) United States
(12) Patent Application Publication
(10) Pub. No.: US 2006/0182519 A1
(43) Pub. Date: Aug. 17, 2006

(54) Spacer tube with guiding indents

(75) Inventors: Michael Welzel, Richmond Hill (CA); Eckhard Hans Schaefer, Richmond Hill (CA)

Correspondence Address: PILLSBURY WINTHROP SHAW PITTMAN, LLP, P.O. BOX 10500, MCLEAN, VA, 22102, US

(73) Assignee: Magna International Inc., Aurora (CA)

(21) Appl. No.: 11/056,603

(22) Filed: Feb. 14, 2005

(51) Int. Cl. F16B 43/02

(52) U.S. Cl. 411/546

(57) ABSTRACT

A one-piece spacer tube for receiving a fastener includes a tubular wall defining a central bore therebetween and a plurality of guiding indents integrally formed in the wall. The indents are arranged in pairs that are longitudinally spaced along the length of the wall. The guiding indents include guiding surfaces that project radially inwardly into the central bore to guide a fastener extending through the central bore.

### BACKGROUND OF THE INVENTION

### Field of the Invention

The present invention relates to a spacer tube used in motor vehicle body.

### SUMMARY OF THE INVENTION

One aspect of the invention relates to a spacer tube for receiving a fastener, including: a generally tubular wall defining a central bore; and guiding indents extending from said wall and projecting radially inwardly into said central bore, said indents being longitudinally spaced from each other along the length of said wall, each of said guiding indents including a guiding surface that is positioned radially inwardly into said central bore to guide a fastener extending through said central bore.

Another aspect of the invention relates to a spacer tube for receiving a fastener, including: a generally tubular wall defining a central bore; and two sets of guiding indents extending from said wall and projecting radially inwardly into said central bore, said two sets being longitudinally spaced from each other along the length of said wall, each indent of said two sets of guiding indents including a guiding surface that is positioned radially inwardly into said central bore to guide a fastener extending through said central bore.

Yet another aspect of the invention relates to a spacer tube for receiving a fastener, having: a generally tubular wall defining a central bore therethrough; and means integrally formed on said wall for guiding a fastener extending through said central bore.

Other aspects, features, and advantages of this invention will become apparent from the following detailed description when taken in conjunction with the accompanying drawings, which are a part of this disclosure and which illustrate, by way of example, the principles of this invention.

### BRIEF DESCRIPTION OF THE DRAWINGS

The accompanying drawings facilitate an understanding of the various embodiments of this invention. In such drawings:

FIG. 1 is a side view illustrating a spacer tube constructed in accordance with an embodiment of the invention;

FIG. 2 is another side view of the spacer tube shown in FIG. 1;

FIG. 3 is another side view of the spacer tube shown in FIG. 1, the spacer tube receiving a fastener therethrough;

FIG. 4 is a bottom view of the spacer tube shown in FIG. 1;

FIG. 5 is a bottom view of the spacer tube shown in FIG. 3;

FIG. 6 is a perspective view illustrating transverse cross-sections A, B, C, and D through lines 6A-6A, 6B-6B, 6C-6C, and 6D-6D, respectively, of the spacer tube shown in FIG. 8;

FIG. 7 is a cross-sectional view through line 7-7 of FIG. 2;

FIG. 8 is a cross-sectional view through line 8-8 of FIG. 4;

FIG. 9 is a cross-sectional view through line 9-9 of FIG. 4;

FIG. 10 is a cross-sectional view through line 10-10 of FIG. 3; and

FIG. 11 is a cross-sectional view through line 11-11 of FIG. 5.

### DETAILED DESCRIPTION OF ILLUSTRATED EMBODIMENTS

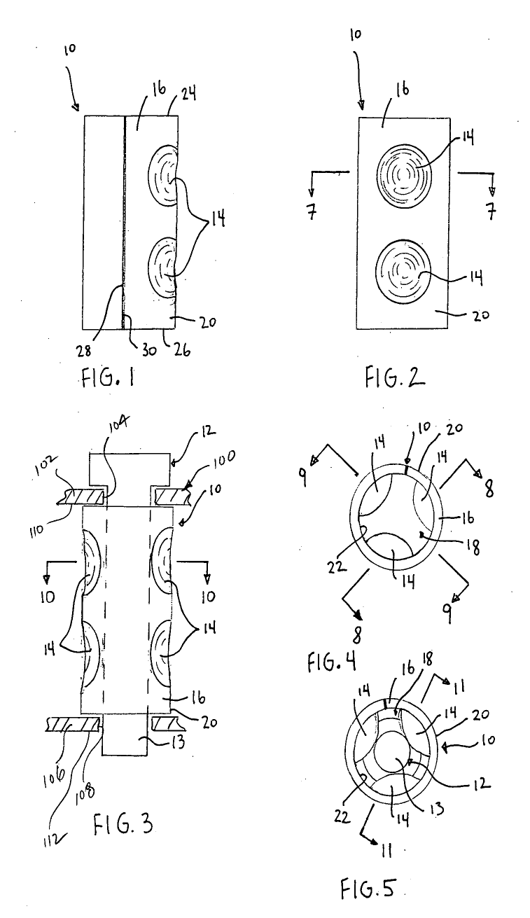

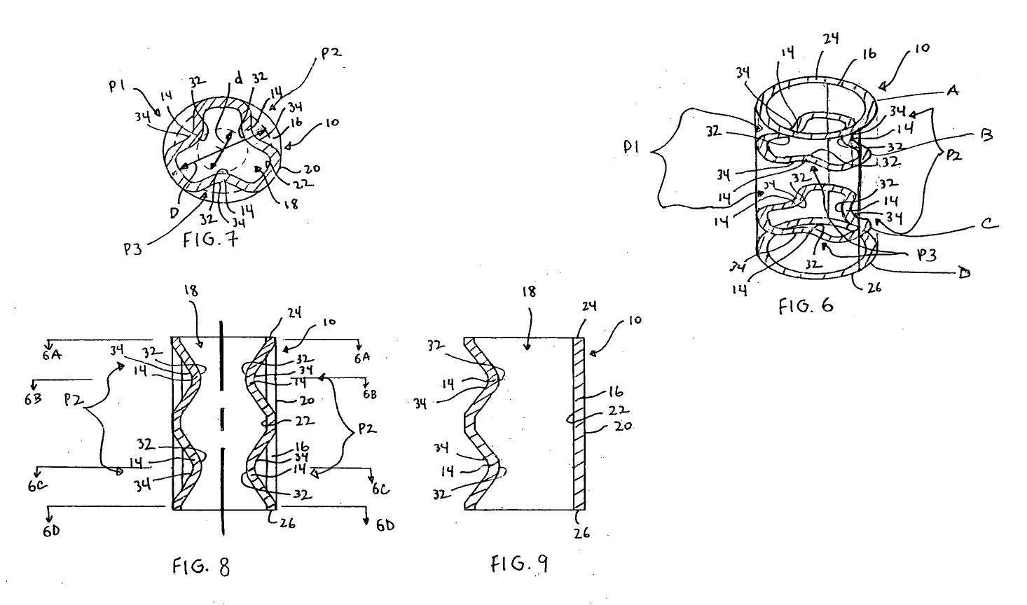

FIGS. 1-5 illustrate a spacer tube 10 constructed according to an embodiment of the present invention. The spacer tube 10 is used in a motor vehicle body or frame, and functions as a fastener guide by guiding a fastener 12, e.g., bolt, therethrough during vehicle assembly. Also, the spacer tube 10 may serve as a reinforcement to the frame member at such location. For example, in FIG. 3, the spacer tube is illustrated as being positioned within a tubular member 100 having a first portion 102 with an annular opening 104 and a second portion 106 having an annular portion 108. The annular openings 104 and 108 are aligned to permit the fastener 12 to pass therethrough and to permit the ends of the tube 10 to abut up against the inner surfaces 110 and 112 of the first and second portions 102 and 106 to provide support to the tubular member 100 against crushing. Thus, the spacer tube 10 can accept fasteners therethrough without the risk of collapsing the tubular member 100.

As discussed in greater detail below, the spacer tube 10 includes a plurality of guiding indents 14 that are configured and arranged to guide a fastener 12 extending through the spacer tube 10. The spacer tube 10 may be utilized in any suitable portion of the vehicle body, and the spacer tube 10 may be utilized on any suitable motor vehicle.

As best shown in FIGS. 1 and 4-9, the spacer tube 10 is formed from a piece of sheet metal that is bent into a cylindrical configuration, e.g., by a die assembly, to provide a one-piece, unitary and integrally-formed spacer tube 10 with a longitudinally extending cylindrical wall 16 that defines a central bore 18 therebetween. The cylindrical wall 16 includes a cylindrical exterior surface 20, a cylindrical interior surface 22, and substantially flat end surfaces 24, 26. Opposing edges 28, 30 of the spacer tube 10 are positioned adjacent to or engaged with one another. These opposing edges 28, 30 may be secured to one another, e.g., by welding. However, the spacer tube 10 may have other configurations, e.g., square configuration, to accommodate other fastening arrangements.

The plurality of guiding indents 14 are integrally formed in the cylindrical wall 16. The indents 14 project radially inwardly into the central bore 18 and cooperate to guide a fastener 12 through the spacer tube 10. As illustrated, each indent 14 has an arcuate configuration that defines a convex guiding surface 32 and a concave exterior surface 34. The concave exterior surface 34 of each indent 14 forms a dimple or recess in the exterior surface 20 of the cylindrical wall 16. Likewise, the convex guiding surface 32 of each indent 14 forms a protrusion in the interior surface 22 of the cylindrical wall 16.

As best shown in FIG. 7, the convex guiding surfaces 32 of the indents 14 cooperate to define a reduced diameter d that is less than a diameter D defined by the interior surface 22. In use, the convex guiding surfaces 32 act as guides that engage the shank portion 13 of a fastener 12 to guide the shank portion 13 through the spacer tube 10 and ensure that the axis of the fastener 12 is in coaxial relation with the axis of the spacer tube 10, as shown in FIGS. 3, 5, 10, and 11. That is, the guiding surfaces 14 combine to form the perimeter of a narrow passageway extending through and being coaxial with the central bore and having a cross-sectional width that is less than the cross-sectional width of the central bore. For example, as illustrated, each of the guiding surfaces 14 of a set of indents 14 are positioned on the circumference of a circle that is coaxial with the central bore.

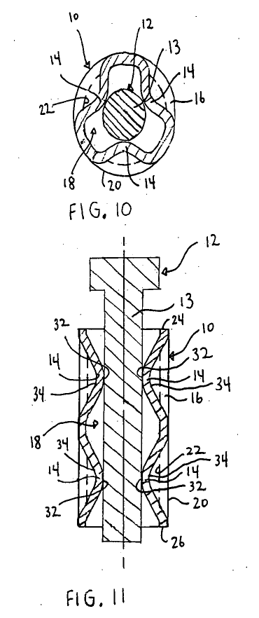

In the illustrated embodiment, the plurality of indents 14 are arranged such that indents 14 are provided in spaced relation longitudinally along the length of the cylindrical wall 16 and in spaced relation circumferentially around the cylindrical wall 16. As best shown in FIGS. 7-8, the spacer tube 10 includes three pairs of indents 14 longitudinally spaced along the cylindrical wall 14. Specifically, a first pair P1 of indents 14 are longitudinally spaced along a portion of the cylindrical wall 16. A second pair P2 of indents 14 are longitudinally spaced along a portion of the cylindrical wall 16, and the second pair P2 of indents 14 are circumferentially spaced from the first pair P1. A third pair P3 of indents 14 are longitudinally spaced along a portion of the cylindrical wall 16, and the third pair P3 of indents 14 are circumferentially spaced from both the first and second pairs P1, P2. Thus, the pairs P1, P2, P3 are equally circumferentially spaced apart from one another. Also, the indents 14 of each pair P1, P2, P3 are longitudinally spaced apart from one another by a distance, and this distance is substantially similar for all three pairs P1, P2, P3. However, the indents 14 may have any other suitable arrangement to guide a fastener through the spacer tube 10.

As noted above, the indents 14 project radially inwardly into the central bore 18. In the illustrated embodiment, the depth of projection of each indent 14 is substantially similar and may be suitably selected to accommodate fasteners of various thicknesses. For example, the spacer tube 10 will have indents 14 that project deeper into the central bore 18 when used with fasteners with thinner shank portions. Also, although the indents 14 are illustrated as being symmetric and having the same radial length from the axis of the tube 10, the indents need not be symmetric and need not be the same radial length from the axis of the tube 10.

In the illustrated embodiment, the indents 14 are integrally formed in one piece along with spacer tube 10. For example, the indents 14 may be formed in the die assembly when the spacer tube 10 is bent into its cylindrical configuration. However, the indents 14 may be formed in the spacer tube 10 in any other suitable manner.

It should understood that three pairs of longitudinally spaced apart indents 14 are merely a preferred embodiment, and that more or less pairs of indents 14 may be provided, e.g., four pairs of longitudinally spaced apart indents. Preferably, at least three pairs of indents 14 are provided to enable a fastener to be coaxially guided through the spacer tube 10. Also, it should be understood that more than a pair of spaced apart indents 14 may be provided longitudinally. For example, three longitudinally spaced apart indents 14 may be provided. Further, the indents 14 may have any other suitable configuration, e.g., non-arcuate configuration, in order to guide a fastener through the spacer tube 10. For example, the spacer tube 10 may have indents that provide substantially flat surfaces that guide a fastener therethrough.

The indents 14 as illustrated are grouped in two sets of three indents 14, with the sets being longitudinally spaced from each other. Each set is shown as having three indents 14 so that the fastener 12 can be easily centered in the bore 18. However, various numbers and configurations of indents arranged around the perimeter of the bore 18 may be used as desired.

The spacer tube 10 with indents 14 described above may be used as a resistance welded tube wherein the spacer tube 10 is welded to a metal base plate. An example of this type of arrangement is disclosed in U.S. Pat. No. 6,188,039, which is incorporated herein by reference thereto.

The foregoing specific embodiments have been provided to illustrate the structural and functional principles of the present invention, and are not intended to be limiting. To the contrary, the present invention is intended to encompass all modifications, alterations, and substitutions within the spirit and scope of the appended claims.

1. A spacer tube for supporting a vehicle frame member and receiving a fastener, comprising:
a generally tubular wall defining a central bore; and
guiding indents integrally formed from said wall to project radially inwardly into said central bore, said indents being longitudinally spaced from each other along a length of said wall, each of said guiding indents including a guiding surface that is positioned radially inwardly into said central bore to guide a fastener extending through said central bore.

2. The spacer tube according to claim 1, wherein said tubular wall has a generally cylindrical configuration.

3. The spacer tube according to claim 1, wherein each of said guiding surfaces combine to form a perimeter of a narrow passageway extending through and being coaxial with said central bore and having a cross-sectional width that is less than the cross-sectional width of said central bore.

4. The spacer tube according to claim 1, wherein each of said guiding surfaces has a concave configuration within said central bore.

5. The spacer tube according to claim 1, wherein said guiding surfaces are arranged to maintain the fastener in coaxial relation with said spacer tube.

6. The spacer tube according to claim 1, wherein said guiding indents include multiple sets of indents, each of said multiple sets being longitudinally spaced from each other along the length of said wall.

7. The spacer tube according to claim 6, wherein each of said sets of said indents includes indents that are equally, circumferentially spaced around said wall.

8. The spacer tube according to claim 7, wherein each of said sets includes three indents.

9. The spacer tube according to claim 8, wherein each of said guiding surfaces of said sets are positioned on the circumference of a circle that is coaxial with said central bore.

10. The spacer tube according to claim 1, wherein said wall and said guiding indents are integrally formed from a one-piece, unitary member.

11. A spacer tube for supporting a vehicle frame member and receiving a fastener, comprising:
a generally tubular metal wall defining a central bore; and
two sets of guiding indents integrally formed from said wall to project radially inwardly into said central bore, said two sets being longitudinally spaced from each other along the length of said wall, each indent of said two sets of guiding indents including a guiding surface that is positioned radially inwardly into said central bore to guide a fastener extending through said central bore.

12. The spacer tube according to claim 11, wherein said indents of each of said two sets are equally, circumferentially spaced around the longitudinal axis of said tubular wall.

13. The spacer tube according to claim 12, wherein each of said sets includes three indents.

14. The spacer tube according to claim 11, wherein said tubular wall has a cylindrical configuration.

15. The spacer tube according to claim 11, wherein each of said guiding surfaces combine to form the perimeter of a narrow passageway extending through and being coaxial with said central bore and having a cross-sectional width that is less than the cross-sectional width of said central bore.

16. The spacer tube according to claim 11, wherein each of said guiding surfaces has a concave configuration within said central bore.

17. The spacer tube according to claim 11, wherein said guiding surfaces maintain the fastener in coaxial relation with said spacer tube.

18. The spacer tube according to claim 11, wherein said wall and each of said guiding indents are integrally formed from a one-piece, unitary member.

19. (canceled)
